(19) United States
(12) Patent Application Publication
(10) Pub. No.: US 2011/0086223 A1
(43) Pub. Date: Apr. 14, 2011

(54) FLUID AND METHOD FOR CLEANING ANTIFOULING COATING, ANTIFOULING COATING REPAIR METHOD, AND UNDERWATER STRUCTURE

(75) Inventors: Takafumi SAKAMOTO, Annaka-shi (JP); Takashi Hagiwara, Osaka-shi (JP); Tokuo Sato, Annaka-shi (JP)

(73) Assignee: Shin-Etsu Chemical Co., Ltd., Tokyo (JP)

(21) Appl. No.: 12/898,097

(22) Filed: Oct. 5, 2010

(30) Foreign Application Priority Data
Oct. 9, 2009 (JP) 2009-235277

(51) Int. Cl. B32B 1/00; C11D 3/60; B05D 3/10

(52) U.S. Cl. 428/357; 510/242; 427/140

(57) ABSTRACT

A cleaning fluid comprising at least two components selected from organic acids, organic acid salts, electrolytes, alcohols, and water is safe. When the existing antifouling coating is to be overcoated or repaired, the surface of the existing coating is cleaned with the cleaning fluid so that a repair coating composition may strongly bond to the existing coating.

### CROSS-REFERENCE TO RELATED APPLICATION

This non-provisional application claims priority under 35 U.S.C. §119(a) on Patent Application No. 2009-235277 filed in Japan on Oct. 9, 2009, the entire contents of which are hereby incorporated by reference.

### TECHNICAL FIELD

This invention generally relates to antifouling coatings applied to underwater structures for preventing aquatic organisms from depositing and growing on their surfaces. More particularly, it relates to a method for cleaning surfaces of antifouling coatings when the coatings are contaminated, a method for cleaning a contaminated antifouling coating, a repairing method of applying a repair antifouling coating composition onto the coating after the coating is cleaned, and an underwater structure having an antifouling coating applied thereby.

### BACKGROUND ART

Underwater structures include ship hulls, harbor facilities, buoys, marine reservoirs, pipe lines, bridges, submarine stations, submarine oil well excavation units, power plant water conduits, fish culture nets and fixed shore nets, and the like. Once underwater structures are installed or in service, aquatic organisms such as barnacles, oysters, mussels, green and brown algae, and the like will deposit or grow on splashed and submerged surface areas, causing various damages.

In the case of a ship, for example, the deposition of organisms to the hull increases frictional resistance to water to reduce the cruise speed. The fuel consumption must be increased to maintain a certain speed, which is uneconomical. When aquatic organisms deposit on structures of a harbor facility which are held at or below the water surface, it becomes difficult for the structures to exert their own functions and sometimes, their substrates can be eroded. When aquatic organisms deposit on fish culture nets or fixed shore nets, net openings are closed, eventually leading to the death of fishes.

Traditional means for preventing deposition and growth of aquatic organisms on underwater structures is the application to such structures of antifouling paints having incorporated therein toxic antifouling agents such as organotin compounds and cuprous oxide. Although such antifouling paints are effective for substantially preventing deposition and growth of aquatic organisms, the use of toxic antifouling agents is harmful to the environment, safety and hygiene during preparation and application of paints. Additionally, the toxic antifouling agent is slowly leached out of the coating in water, with the risk of pollution of the surrounding water area over a long term. For this reason, the use of toxic antifouling agents was legally banned.

There have been proposed paint compositions which are effective for preventing deposition and growth of aquatic organisms, but free of toxic antifouling agents. JP-A 58-13673 and JP-A 62-84166 describe paint compositions which are designed to impart antifouling property by reducing the surface tension of coatings include non-toxic antifouling paint compositions comprising room temperature-curable silicone rubber and liquid paraffin or petrolatum. Japanese Patent Nos. 2503986 and 2952375 disclose non-toxic antifouling paint compositions comprising a reaction curable silicone resin and a less compatible, non-reactive, polar group-containing silicone resin wherein under the impetus of volume shrinkage associated with curing of the reaction curable silicone resin, the polar group-containing silicone resin bleeds out of the surface, which cooperates with the low surface tension of the reaction curable silicone resin to exhibit antifouling property.

Recently, WO 02074870 discloses an anti-deposition composition comprising a fluorinated alkyl-containing polymer utilizing low surface tension. WO 01094446 discloses an antifouling coating composition comprising a curable fluoro-resin.

Coating compositions free of toxic antifouling agents have been used in practice. Replacement and repair of the existing coatings containing toxic antifouling agents have been promoted from the standpoint of safety.

The replacement and repair operation may be performed by either a method of working after the existing coating has been completely removed or another method of cleaning the surface of the existing coating and applying an overcoat for repair. Apparently, the latter method is advantageous in cost because of a reduced number of steps.

In the case of an underwater structure, the surface of a coating on the structure often has carried thereon deposits of organisms and deposits of contaminants from seawater or is degraded under the impact of UV radiation, water and temperature. It is difficult to overcoat a repair paint directly on the existing coating surface. Usually the existing coating is cleaned by water jet washing or the like before overcoating. However, such washing fails to improve the adhesion between the existing coating and an overlay coating.

### CITATION LIST

Patent document 1: JP-A 58-13673
Patent document 2: JP-A 62-84166
Patent document 3: JP 2503986
Patent document 4: U.S. Pat. No. 5,218,059 (JP 2952375)
Patent Document 5: WO 02074870 (JP-A 2004-531600)
Patent Document 6: WO 01094446 (JP-A 2003-535938)

### DISCLOSURE OF INVENTION

An object of the invention is to provide a safe cleaning fluid for antifouling coatings and a method for cleaning an antifouling coating therewith. Specifically, when the previous (or existing) coating is to be overcoated or repaired, the surface of the previous coating is cleaned with the cleaning fluid so that a repair coating composition may strongly bond to the previous coating. Another object of the invention is to provide a repair method of applying a coating composition after cleaning as above and an underwater structure having a coating applied by the repair method.

The inventors sought for a cleaning fluid featuring safety. It has been found that when a cleaning fluid comprising, in combination, at least two components selected from the group consisting of organic acids, organic acid salts, electrolytes, alcohols, and water which are legally assigned as food additives is used for cleaning of an antifouling coating which has been applied to a structure, the antifouling coating is significantly improved in receptivity or adhesion to a repair coating composition to be subsequently applied.

Since the cleaning fluid consists of components which are allowable as food additives, it displays high safety. By cleaning a previous coating (which has suffered degradation by sunlight and seawater over a long period of time) with the cleaning fluid, the surface state of the previous coating is drastically improved and sometimes, deposits from seawater are effectively removed. Once the previous coating is cleaned with the cleaning fluid, a repair coating composition is applied thereon. The adhesion of the repair coating to the previous coating is significantly improved. The invention is predicated on these findings.

One embodiment of the invention is a cleaning fluid for antifouling coatings comprising at least two components selected from the group consisting of organic acids, organic acid salts, electrolytes, alcohols, and water.

Preferably the cleaning fluid comprises an alcohol, water, and at least one component selected from the group consisting of organic acids, organic acid salts, and electrolytes. The organic acid and organic acid salt are preferably selected from among acetic acid, lactic acid, citric acid, malic acid, tartaric acid, succinic acid, fumaric acid, and salts thereof.

Another embodiment of the invention is a method for cleaning an antifouling coating, comprising cleaning a contaminated antifouling coating with the cleaning fluid of the one embodiment.

Typically, the antifouling coating is of a coating composition for preventing deposition of aquatic organisms.

A further embodiment of the invention is a method for repairing an antifouling coating, comprising cleaning a contaminated surface of the antifouling coating by the method of the other embodiment, and applying a repair antifouling coating composition to the cleaned surface.

Typically the repair antifouling coating composition is a curable silicone resin base coating composition.

A still further embodiment of the invention is an underwater structure having an antifouling coating applied thereon by the repairing method.

### ADVANTAGEOUS EFFECTS OF INVENTION

The method for cleaning an antifouling coating on an underwater structure with the cleaning fluid is successful in removing any deposits on the surface of the antifouling coating in a safe and simple way. A new antifouling coating which is obtained by applying a repair coating composition after the cleaning step is strongly bondable to the cleaned surface of the antifouling coating. Then the method is suited for overcoating and repair of an antifouling coating.

### DESCRIPTION OF EMBODIMENTS

According to the invention, the cleaning fluid for antifouling coatings is defined as comprising in combination at least two components selected from the group consisting of organic acids, organic acid salts, electrolytes, alcohols, and water. Two or more of these components, when combined, act in synergism to exert a sufficient cleaning effect. Two or more components may be selected from materials of different type, like a combination of an organic acid with an electrolyte, or a combination of an organic acid with an alcohol, for example, or from materials of the same type, like a combination of plural organic acids, for example. It is provided that when one component is an alcohol or water, it is used in combination with another type, i.e., an organic acid, organic acid salt or electrolyte. One preferred embodiment is a cleaning fluid comprising an alcohol, water, and at least one component selected from the group consisting of organic acids, organic acid salts, and electrolytes.

Suitable organic acids include L-ascorbic acid, citric acid, acetic acid, succinic acid, tartaric acid, lactic acid, propionic acid, butyric acid, DL-malic acid, L-malic acid, and fumaric acid. These acids are assigned as food additives and safe. Of these acids, citric acid, acetic acid, succinic acid, tartaric acid, lactic acid, DL-malic acid, L-malic acid, and fumaric acid are preferred because they are effective not only for cleaning away seawater ingredients deposited on the coating, but also for sterilizing microorganisms.

Suitable organic acid salts include salts of the foregoing organic acids which are acceptable as the food additives, for example, potassium and sodium salts. Preferred examples include monopotassium citrate, tripotassium citrate, calcium citrate, trisodium citrate, monosodium succinate, disodium succinate, potassium hydrogen DL-tartrate, sodium DL-tartrate, sodium L-tartrate, calcium lactate, potassium propionate, sodium propionate, and sodium malate.

When the organic acids and organic acid salts are used, they are added to the cleaning fluid in such amounts as to give a total concentration of at least 0.2%, more preferably at least 0.5%, and even more preferably at least 1% by weight of the acids and salts. An amount of the acids and salts below the specified level may lead to a decline of the cleaning effect. No upper limit is imposed on the amount of the acids and salts used. Although higher concentrations provide a better cleaning effect, a concentration of up to 20% by weight, preferably up to 10% by weight is desirable from the standpoint of cost.

Suitable electrolytes include those assigned as the food additives. Preferred examples include sodium chloride (known as edible salt), potassium chloride, magnesium sulfate, magnesium chloride, and calcium chloride. Of these, magnesium sulfate, sodium chloride, potassium chloride, and calcium chloride are especially preferred.

When the electrolytes are used, they are added to the cleaning fluid in such amounts as to give a concentration of at least 0.5%, more preferably at least 1% by weight. An amount of the electrolyte below the specified level may lead to a decline of the cleaning effect. With respect to the upper limit of the addition amount, a concentration of up to 10% by weight, preferably up to 5% by weight is desirable from the standpoint of cost.

Of the alcohols, ethanol is desirably used for safety. In the practice of the invention, an alcohol such as ethanol is used for the purpose of promoting dispersion of the other component(s) on the coating surface.

When the alcohols are used, they are added to the cleaning fluid in such amounts as to give a concentration of at least 0.5%, more preferably at least 1% by weight. An amount of the alcohol below the specified level may lead to a decline of the cleaning effect. With respect to the upper limit of the addition amount, a concentration of up to 50% by weight, preferably up to 30% by weight is desirable from the standpoint of cost.

Water used herein is preferably electrolyzed water. When water is used, it is added to the cleaning fluid in an amount of at least 10%, more preferably at least 15% by weight. An amount of water below the specified level may lead to a decline of the cleaning effect. With respect to the upper limit of the addition amount, an amount of up to 98% by weight, preferably up to 97% by weight is desirable for the cleaning effect.

In the cleaning fluid for antifouling coatings, at least two components selected from the foregoing are used in combination. In a preferred embodiment, the cleaning fluid contains an organic acid and/or organic acid salt selected from the group consisting of acetic acid, lactic acid, citric acid, malic acid, tartaric acid, succinic acid, fumaric acid, and salts thereof, or an electrolyte selected from the group consisting of magnesium sulfate, sodium chloride, potassium chloride, and calcium chloride, and ethanol. In a more preferred embodiment, the cleaning fluid contains at least 0.2% by weight of an organic acid and/or organic acid salt, at least 0.5% by weight of an alcohol, and at least 10% by weight of water.

The cleaning fluid is preferably at pH 5 or below, more preferably at pH 4 or below. The pH level of the cleaning fluid may be adjusted using a pH-adjusting component, for example, an organic acid such as citric acid or DL-malic acid, or a salt thereof, a carbonate salt such as sodium carbonate, or a phosphoric acid such as phosphoric acid.

By virtue of the cooperation or synergism of the respective components, the cleaning fluid is effective for cleaning away seawater ingredients deposited on the coating surface and for sterilizing microorganisms, achieving a drastically improved cleaning effect. The cleaning fluid may also be formulated by blending specific components selected from the compounds exemplified in JP-A H08-289768, JP-A H11-246312, and JP-A 2006-304712.

The cleaning fluid is effective for cleaning antifouling coatings applied to underwater structures such as ships, harbor facilities, buoys, marine reservoirs, pipe lines, bridges, submarine stations, submarine oil well excavation units, power plant water conduits, fish culture nets and fixed shore nets. The antifouling coatings to be cleaned are not particularly limited and include cured coatings of commercially available antifouling paints, and preferably cured coatings of coating compositions for preventing aquatic organisms from deposition. Typical are antifouling coating compositions based on curable organic polymers such as acrylic and silicone polymers. The coating compositions may contain a bleeding silicone oil or a component for enhancing the effectiveness of antifouling agents. An intermediate coating such as a corrosion preventive coating may intervene between the antifouling coating and the substrate of the underwater structure.

In the antifouling coating compositions, the curable organic polymers are major components which cure to form a coating film. Any organic polymers may be used which cure at room temperature (less than about 50° C.) or at elevated temperatures (at least 50° C.), or upon exposure to UV radiation or electron beams. Suitable organic polymers include vinyl chloride copolymer resins such as vinyl chloride-vinyl acetate copolymer resins, vinyl chloride-vinyl acetate-vinyl alcohol copolymer resins, vinyl chloride-vinyl isobutyl ether copolymer resins, and vinyl chloride-vinyl propionate copolymer resins; chlorinated rubber resins, chlorinated olefin resins, (meth)acrylate copolymer resins, acrylic resins such as silyl(meth)acrylic resins resulting from silyl esterification, styrene-butadiene copolymer resins, acrylic urethane resins, polyurethane resins, polysulfide resins, and silicone resins. Such polymers may be composed of a single component or two or multiple components. From the standpoint of working efficiency, those polymers which cure at room temperature are preferred.

Another embodiment is a method of cleaning an antifouling coating with the cleaning fluid defined herein. The method may be implemented by cleaning, washing or scrubbing using scrub brushes, polisher brushes or rags, or by cleaning using a high-pressure cleaning machine.

In a further embodiment, an antifouling coating is repaired by cleaning a contaminated surface of the antifouling coating with the cleaning fluid, and applying a repair antifouling coating composition to the cleaned surface. The repair antifouling coating composition which is used after cleaning of a previous antifouling coating is not particularly limited and is preferably a coating composition for preventing aquatic organisms from deposition. Suitable coating compositions include those based on curable organic polymers as described above, and especially those based on curable silicone resins. The curable silicone resin base coating compositions used herein are not particularly limited, and examples include commercially available antifouling coating compositions and the curable compositions described in Patent Documents 1 to 6.

In the curable silicone resin base coating compositions, organopolysiloxanes are used as the base polymer. The organopolysiloxanes used herein have cure reactive groups such as hydroxyl, C₁-C₈ alkoxy, vinyl or (meth)acrylic groups. Hydrolyzable groups other than hydroxyl include alkoxy groups such as methoxy, ethoxy, and propoxy; alkoxyalkoxy groups such as methoxyethoxy, ethoxyethoxy, and methoxypropoxy; acyloxy groups such as acetoxy, octanoyloxy and benzoyloxy; alkenyloxy groups such as vinyloxy, isopropenyloxy, and 1-ethyl-2-methylvinyloxy; ketoxime groups such as dimethylketoxime, methylethylketoxime, and dimethylketoxime; amino groups such as dimethylamino, diethylamino, butylamino, and cyclohexylamino; aminoxy groups such as dimethylaminoxy and diethylaminoxy; and amide groups such as N-methylacetamide, N-ethylacetamide, and N-methylbenzamide.

The organopolysiloxanes may have organic groups other than the cure reactive groups, examples of which include alkyl groups such as methyl, ethyl, propyl, butyl, pentyl, hexyl, heptyl, octyl, nonyl, decyl, and octadecyl; cycloalkyl groups such as cyclopentyl and cyclohexyl; alkenyl groups such as vinyl, allyl, butenyl, pentenyl, and hexenyl; aryl groups such as phenyl, tolyl, xylyl, α- and β-naphthyl; aralkyl groups such as benzyl, 2-phenylethyl, and 3-phenylpropyl; and substituted forms of the foregoing in which some or all hydrogen atoms are replaced by halogen atoms (F, Cl, Br), cyano or other groups, such as 3-chloropropyl, 3,3,3-trifluoropropyl, and 2-cyanoethyl. Of these, methyl, ethyl, vinyl, and phenyl are preferred, with methyl being most preferred.

The organopolysiloxane may have such a degree of polymerization as to give a viscosity at 23° C. of 20 to 1,000,000 mPa-s, preferably 100 to 500,000 mPa-s, and more preferably 1,000 to 50,000 mPa-s. If the viscosity is less than 20 mPa-s at 23° C., it may become difficult to form a coating film having good physical and mechanical strength. Inversely, if the viscosity is above 1,000,000 mPa-s at 23° C., then the coating composition may have too high a viscosity to work. As used herein, the viscosity is measured by a rotational viscometer.

Along with the organopolysiloxane, a silane and/or partial hydrolytic condensate may be used as the crosslinker. The silane compound used herein is not particularly limited as long as it contains at least two hydrolyzable groups in a molecule. Preferably the silane compound has at least three hydrolyzable groups while it may have other groups bonded to silicon atoms. Its molecular structure may be either a silane or siloxane structure. The compounds of siloxane structure may be straight, branched or cyclic.

Suitable organic groups other than the hydrolyzable groups include substituted or unsubstituted monovalent hydrocarbon groups of 1 to 6 carbon atoms, for example, alkyl groups such as methyl, ethyl, propyl, butyl, pentyl, and hexyl; cycloalkyl groups such as cyclopentyl and cyclohexyl; aryl groups such as phenyl and tolyl; aralkyl groups such as benzyl and 2-phenylethyl; alkenyl groups such as vinyl, allyl, butenyl, pentenyl, and hexenyl; and halogenated alkyl groups such as 3,3,3-trifluoropropyl and 3-chloropropyl. Of these, methyl, ethyl, phenyl, and vinyl are preferred.

Examples of the silane and partial hydrolytic condensate thereof include ethyl silicate, propyl silicate, methyltrimethoxysilane, methyltriethoxysilane, vinyltrimethoxysilane, vinyltriethoxysilane, methyltris(methoxyethoxy)silane, vinyltris(methoxyethoxy)silane, methyltripropenoxysilane, methyltriacetoxysilane, vinyltriacetoxysilane, methyltri(methylethylketoxime)silane, vinyltri(methylethylketoxime)silane, phenyltri(methylethylketoxime)silane, propyltri(methylethylketoxime)silane, tetra(methylethylketoxime)silane, 3,3,3-trifluoropropyltri(methylethylketoxime)silane, 3-chloropropyltri(methylethylketoxime)silane, methyltri(dimethylketoxime)silane, methyltri(dimethylketoxime)silane, methyltri(methylisopropylketoxime)silane, tri(cyclohexanoxime)silane, and partial hydrolytic condensates thereof. These silanes may be used alone or in admixture of two or more.

The silane and/or partial hydrolytic condensate thereof is preferably blended in an amount of 0.5 to 20 parts, more preferably 1 to 10 parts by weight per 100 parts by weight of the organopolysiloxane. If the amount of the silane is less than 0.5 pbw, then insufficient crosslinking may occur. If the amount of the silane is more than 20 pbw, there may arise problems of too hard cured products and increased costs.

A silicone oil may be added to the antifouling coating composition to improve its antifouling effect. The silicone oil tends to bleed out of the coating surface to prevent microorganisms from deposition. Suitable silicone oils include dimethylsilicone oil in which all organic groups are methyl, methylphenylsilicone oil obtained by substituting phenyl for some methyl groups in the dimethylsilicone oil, amino-modified silicone oil obtained by substituting monoamine, diamine or amino-polyether groups therefor, epoxy-modified silicone oil obtained by substituting epoxy, alicyclic epoxy, epoxy-polyether or epoxy-aralkyl groups therefor, carbinol-modified silicone oil obtained by substituting carbinol groups therefor, mercapto-modified silicone oil obtained by substituting mercapto groups therefor, carboxyl-modified silicone oil obtained by substituting carboxyl groups therefor, methacryl-modified silicone oil obtained by substituting methacrylic groups therefor, polyether-modified silicone oil obtained by substituting polyether groups therefor, long-chain alkyl-modified silicone oil obtained by substituting long-chain alkyl or long-chain alkyl-aralkyl groups therefor, higher fatty acid-modified silicone oil obtained by substituting higher fatty acid ester groups therefor, and fluoroalkyl-modified silicone oil obtained by substituting fluoroalkyl groups therefor. Among others, the methylphenylsilicone oil, polyether-modified silicone oil, and long-chain alkyl-modified silicone oil may be used alone or in admixture.

One or more of the foregoing silicone oils are desirably used in a total amount of 5 to 150 parts, more preferably 10 to 100 parts by weight per 100 parts by weight of the curable organic polymer. An amount of the silicone oil within the range ensures to form an antifouling coating having both good antifouling property and high film strength whereas an amount below the range may lead to poor antifouling property and an amount above the range may lead to a low film strength.

An antifouling agent may be used in the antifouling coating composition. The antifouling agent may be either inorganic or organic. The inorganic antifouling agent may be any of prior art well-known agents, preferably copper and inorganic copper compounds. The organic antifouling agent may be any of prior art well-known agents, for example, metal pyrithiones having the formula (i):

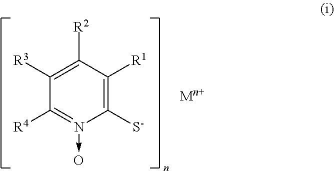

wherein R¹ to R⁴ are each independently hydrogen, an alkyl, alkoxy, or halogenated alkyl group, M is a metal such as Cu, Zn, Na, Mg, Ca, Ba, Pb, Fe, or Al, and n is the valence of M; tetramethylthiuram disulfide, carbamate compounds (e.g., zinc dimethyldithiocarbamate and manganese 2-ethylenebisdithio-carbamate), 2,4,5,6-tetrachloroisophthalonitrile, N,N-dimethyldichlorophenyl urea, 4,5-dichloro-2-n-octyl-3(2H)isothiazoline, 2,4,6-trichlorophenylmaleimide, and 2-methylthio-4-t-butylamino-6-cyclopropyl-s-triazine.

Of the organic antifouling agents mentioned above, preference is given to copper pyrithione (formula (i) wherein M=Cu), zinc pyrithione (formula (i) wherein M=Zn), N,N-dimethyldichlorophenyl urea, 2,4,6-trichlorophenylmaleimide, 2-methylthio-4-t-butylamino-6-cyclopropyl-s-triazine, 4,5-dichloro-2-n-octyl-4-isothiazolin-3-one, and 2,4,5,6-tetrachloroisophthalonitrile.

Of the organic antifouling agents mentioned above, the metal pyrithiones and/or 4,5-dichloro-2-n-octyl-4-isothiazolin-3-one is preferred, with a mixture thereof being more preferred because of better antifouling effect. In particular, copper pyrithione and/or 4,5-dichloro-2-n-octyl-4-isothiazolin-3-one is preferred, with a mixture thereof being more preferred.

The organic antifouling agent, when used, is preferably added in an amount of 0.1 to 20%, more preferably 0.5 to 10% by weight based on the antifouling coating composition. The inorganic antifouling agent, when used, is preferably added in an amount of 0.5 to 50%, more preferably 1 to 20% by weight based on the antifouling coating composition.

To the antifouling coating composition used herein, a catalyst for promoting cure may be added. The curing catalyst may be selected from those commonly used in room temperature-curable compositions of the condensation cure type, for example,

metal salts of organic carboxylic acids such as lead 2-ethyloctoate, dimethyltin dioctoate, dimethyltin acetate, dimethyltin dilaurate, dibutyltin dioctoate, dibutyltin acetate, dibutyltin dilaurate, butyltin 2-ethylhexoate, dioctyltin dioctoate, dioctyltin acetate, dioctyltin dilaurate, iron 2-ethylhexoate, cobalt 2-ethylhexoate, manganese 2-ethylhexoate, zinc 2-ethylhexoate, stannous caprate, tin naphthenate, tin oleate, tin butanoate, titanium naphthenate, zinc naphthenate, cobalt naphthenate, and zinc stearate;
organic titanates such as tetrabutyl titanate, tetra-2-ethylhexyl titanate, triethanolamine titanate, and tetra(isopropenyloxy)titanate;
organic titanium compounds and organic titanium chelates such as organosiloxytitanium, β-carbonyltitanium, diisopropoxytitanium bis(ethylacetoacetate), and tetra(acetylacetonato)titanium;
alkoxyaluminum compounds, aminoalkyl-substituted alkoxysilanes such as 3-aminopropyltriethoxysilane and N-(trimethoxysilylpropyl)ethylenediamine;
amine compounds and salts thereof such as hexylamine and dodecylamine phosphate;
alkali metal salts of lower fatty acids such as potassium acetate, sodium acetate, and lithium bromate;
dialkylhydroxylamines such as dimethylhydroxylamine and diethylhydroxylamine; and
guanidyl-containing silanes and siloxane of the following formulae.

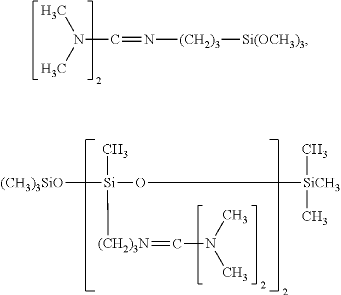

These curing catalysts may be used alone or in admixture of two or more.

When the curing catalyst is used, its amount is not particularly limited. The catalyst may be used in a catalytic amount, specifically 0.01 to 20 parts, and preferably 0.1 to 10 parts by weight per 100 parts by weight of the organopolysiloxane. If the amount of the catalyst is below the range, then the antifouling coating composition may become less curable depending on the type of crosslinker. If the amount of the catalyst is above the range, then the antifouling coating composition may become unstable during shelf storage.

A filler may be used for the reinforcing or extending purpose. Suitable fillers include fumed silica, quartz, diatomaceous earth, titanium oxide, aluminum oxide, lead oxide, iron oxide, carbon black, bentonite, graphite, calcium carbonate, mica, clay, glass beads, glass microballoons, shirasu balloons, glass fibers, polyvinyl chloride beads, polystyrene beads, and acrylic beads.

When the filler is used, its amount is not particularly limited. The filler may be used in an amount of 1 to 50 parts, and preferably 5 to 30 parts by weight per 100 parts by weight of the organopolysiloxane. If the amount of the filler is below the range, then the cured rubber may have poor physical properties. If the amount of the filler is above the range, then the antifouling coating composition may have too high a viscosity, aggravating the working efficiency during mixing and coating steps.

If necessary, plasticizers, colorants (e.g., pigments), flame retardants, thixotropic agents, antiseptic agents, mold-proof agents, and adhesion promoters, typically carbon-functional silanes having amino, epoxy or thiol groups (e.g., γ-glycidoxypropyltrimethoxysilane and aminopropyl-triethoxysilane) may be added in conventional amounts as long as they do not impair the objects of the invention.

The antifouling coating composition preferably has a viscosity suited for coating, typically up to 50,000 mPa-s at 23° C., more preferably up to 30,000 mPa-s at 23° C.

The antifouling coating composition described above is used for repair. After a previous antifouling coating applied to an underwater structure (e.g., such as ships, harbor facilities, buoys, marine reservoirs, pipe lines, bridges, submarine stations, submarine oil well excavation units, power plant water conduits, fish culture nets and fixed shore nets) is contaminated, the contaminated antifouling coating is cleaned with the cleaning fluid described herein and the antifouling coating composition is subsequently applied onto the cleaned antifouling coating. The cured film of the antifouling coating composition is non-toxic, non-detrimental to the environment, and effective for preventing deposition and growth of aquatic organisms over a long period of time, exhibiting excellent antifouling effect.

The antifouling coating composition may be applied by any of brush coating, spraying, flow coating and other coating techniques.

The coating weight of the antifouling coating composition on the underwater structure is not particularly limited, and may be properly selected depending on a particular application and shape. The thickness of a cured coating is preferably in the range of 10 to 1,000 μm, more preferably 50 to 500 μm. Preferably the antifouling coating composition is applied and cured at room temperature.

### Example

Examples of the invention are given below by way of illustration and not by way of limitation. All parts are by weight.

### Preparation Example 1

100 parts of α,ω-dihydroxy-dimethylpolysiloxane having a viscosity of 1,500 mPa-s and 10 parts of fumed silica having a BET specific surface area of 110 m²/g were uniformly blended and heat mixed under reduced pressure at 150° C. for 2 hours. The mixture was further combined with 12 parts of vinyltris(methylethylketoxime)silane and 1 part of γ-aminopropyltriethoxysilane, and mixed under reduced pressure until uniform, yielding composition #1.

### Preparation Example 2

To composition #1 was added 15 parts of α,ω-trimethylsiloxy-methylphenylpolysiloxane having a viscosity of 300 mPa-s. The ingredients were mixed under reduced pressure until uniform, yielding composition #2.

### Preparation Example 3

A composition #3 was prepared by mixing 100 parts of vinyl chloride-isobutyl ether copolymer (Laroflex®, BASF) with 25 parts of zinc white, 5 parts of fumed silica having a BET specific surface area of 110 m²/g, 25 parts of talc, 20 parts of xylene, and 20 parts of methyl isobutyl ketone until uniform.

### Preparation Example 4

To composition #3 was added 15 parts of α,ω-trimethylsiloxy-methylphenylpolysiloxane having a viscosity of 300 mPa-s. The ingredients were mixed under reduced pressure until uniform, yielding composition #4.

### Preparation Example 5

A four-neck flask equipped with a stirrer, thermometer, reflux condenser, N₂ gas inlet tube, and dropping funnel was charged with 40 parts of xylene and heated at 90° C. while feeding N₂ gas. From the dropping funnel, a mixture X consisting of 20 parts of tris(trimethylsiloxy)-γ-methacryloyloxypropylsilane, 50 parts of methyl methacrylate, 30 parts of butyl acrylate, and 1 part of azobisisobutyronitrile was added dropwise over 3 hours. After the completion of dropwise addition, the solution was aged at 90° C. for 4 hours and cooled, yielding composition #5.

### Preparation Example 6

To composition #5 was added 15 parts of α,ω-trimethylsiloxy-methylphenylpolysiloxane having a viscosity of 300 mPa-s. The ingredients were mixed under reduced pressure until uniform, yielding composition #6.

### Example

Plates pre-coated with an epoxy-base corrosion preventive paint to a coating thickness of 150 μm were coated with compositions #1 to #6 to a coating thickness of 200 μm. The coated plates were held at 23° C. and 50% RH for 7 days for thereby curing the coatings. The resulting test samples were immersed in seawater for 6 and 12 months, after which an adhesion test was carried out.

The test samples after seawater immersion were cleaned by high-pressure washing with cleaning fluid 1 or 2, to be described below. Then the samples were coated with composition #1 to a coating thickness of 200 μm and held at 23° C. and 50% RH for 7 days for thereby curing the new coatings. The cured film of composition #1 was examined for adhesion according to the cross-cut test method of JIS K 5600-5-6.

Cleaning Fluid 1

It was prepared by combining 1 wt % of acetic acid, 1 wt % of citric acid, 1 wt % of ethanol, and 97 wt % of deionized water and adjusting pH to approximately 2.5.

Cleaning Fluid 2

It was prepared by combining 5 wt % of citric acid, 20 wt % of ethanol, and 75 wt % of deionized water and adjusting pH to approximately 2.5.

### Comparative Example

The procedure of Example was repeated except that deionized water was used instead of cleaning fluid 1 or 2.

The test results are expressed by ratings according to the cross-cut test of JIS K 5600-5-6 and reported in Table 1.

TABLE 1

| | | | | | Comparative |
|---|---|---|---|---|---|
| | Seawater | | Example | | Example |
| | immersion | | Cleaning | Cleaning | Deionized |
| Coated plate | period | | fluid 1 | fluid 2 | water |
| Composition #1 | 6 | months | 0 | 0 | 3 |
| | 12 | months | 0 | 0 | 4 |
| Composition #2 | 6 | months | 0 | 0 | 4 |
| | 12 | months | 1 | 0 | 5 |
| Composition #3 | 6 | months | 0 | 0 | 5 |
| | 12 | months | 2 | 1 | 5 |
| Composition #4 | 6 | months | 1 | 1 | 5 |
| | 12 | months | 2 | 2 | 5 |
| Composition #5 | 6 | months | 0 | 0 | 4 |
| | 12 | months | 1 | 1 | 5 |
| Composition #6 | 6 | months | 1 | 0 | 5 |
| | 12 | months | 2 | 1 | 5 |

Japanese Patent Application No. 2009-235277 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A cleaning fluid for antifouling coatings comprising at least two components selected from the group consisting of organic acids, organic acid salts, electrolytes, alcohols, and water.

2. The cleaning fluid of claim 1 comprising an alcohol, water, and at least one component selected from the group consisting of organic acids, organic acid salts, and electrolytes.

3. The cleaning fluid of claim 1 wherein the organic acid and organic acid salt are selected from the group consisting of acetic acid, lactic acid, citric acid, malic acid, tartaric acid, succinic acid, fumaric acid, and salts thereof.

4. A method for cleaning an antifouling coating, comprising cleaning a contaminated antifouling coating with the cleaning fluid of claim 1.

5. The cleaning method of claim 4 wherein the antifouling coating is of a coating composition for preventing aquatic organism deposition.

6. A method for repairing an antifouling coating, comprising
cleaning a contaminated surface of the antifouling coating by the method of claim 4, and
applying a repair antifouling coating composition to the cleaned surface.

7. The repairing method of claim 6 wherein the repair antifouling coating composition is a curable silicone resin base coating composition.

8. An underwater structure having an antifouling coating applied thereon by the repairing method of claim 6.
